(19) United States
(12) Patent Application Publication
(10) Pub. No.: US 2016/0170495 A1
(43) Pub. Date: Jun. 16, 2016

(54) GESTURE RECOGNITION APPARATUS, VEHICLE HAVING THE SAME, AND METHOD FOR CONTROLLING THE VEHICLE

(71) Applicant: HYUNDAI MOTOR COMPANY, Seoul (KR)

(72) Inventor: Hyungsoon PARK, Seoul (KR)

(21) Appl. No.: 14/958,676

(22) Filed: Dec. 3, 2015

(30) Foreign Application Priority Data
Dec. 10, 2014 (KR) 10-2014-0177422

(51) Int. Cl. G06F 3/01; G06K 9/00

(52) U.S. Cl. CPC G06F 3/017; G06K 9/00355

(57) ABSTRACT

A gesture recognition apparatus, a vehicle having the same, and a method for controlling the vehicle are disclosed. A gesture recognition apparatus includes a collection unit having a single sense region, configured to collect information regarding a user gesture conducted in the sense region. The gesture recognition apparatus also includes a controller to detect coordinates and a space vector of the gesture on the basis of a predetermined vehicle coordinate system, and to determine an electronic device from among a plurality of electronic devices on the basis of the gesture coordinates and the space vector to be a gesture recognition object.

### CROSS-REFERENCE TO RELATED APPLICATION

This application claims the benefit of Korean Patent Application No. 2014-0177422, filed on Dec. 10, 2014, in the Korean Intellectual Property Office, the disclosure of which is incorporated herein in its entirety by reference.

### TECHNICAL FIELD

Embodiments of the present invention relate to a gesture recognition apparatus, a vehicle having the same, and a method for controlling the vehicle.

### BACKGROUND

A vehicle can perform basic traveling functions and additional functions for user convenience, for example, an audio function, a video function, a navigation function, an air-conditioning control function, a seat control function, an illumination control function, etc.

Electronic devices configured to perform respective functions are embedded in the vehicle. An input unit configured to receive operation commands of the electronic devices is also embedded in the vehicle. This input unit may be implemented by at least one of various schemes, for example, a hard key scheme, a touchscreen scheme, a voice recognition scheme, a gesture recognition scheme, etc.

### SUMMARY

Various embodiments of the present invention are directed to providing a gesture recognition apparatus, a vehicle having the same, and a method for controlling the vehicle that substantially obviate one or more problems due to limitations and disadvantages of the related art.

Therefore, it is an aspect of the present disclosure to provide a gesture recognition apparatus for determining intention of a user's gesture on the basis of a vehicle coordinate system, a vehicle having the same, and a method for controlling the vehicle.

Additional aspects will be set forth in part in the description which follows and, in part, will be obvious from the description, or may be learned by practice of the disclosure.

In accordance with one aspect of the present disclosure, a gesture recognition apparatus includes: a collection unit having a single sense region, configured to collect information regarding a user gesture conducted in the sense region; and a controller to detect coordinates and a space vector of the user gesture on the basis of a predetermined vehicle coordinate system, and to determine an electronic device from among a set of electronic devices on the basis of the gesture coordinates and the space vector to be a gesture recognition object.

The predetermined vehicle coordinate system may include a coordinate system based on an internal design drawing of a vehicle.

The controller may detect the coordinates and the space vector of the user gesture with respect to the vehicle coordinate system on the basis of a position of the collection unit with respect to the vehicle coordinate system.

The controller may determine an electronic device located at an extension line of the space vector from among the set of electronic devices to be a gesture recognition object.

The gesture recognition may further include: an output unit configured to output an operation command based on the collected gesture information to the gesture recognition object.

The collected gesture information may include at least one selected from among a group consisting of hand information, finger information, and arm information of the user.

The collection unit may include: an image collection unit configured to collect an image of the user gesture so as to recognize the gesture.

The collection unit may include: a photo sensor to receive light reflected from the user gesture.

The collection unit may collect at least one of user's face information and user's gaze information.

The controller may detect coordinates and a space vector of the user face on the basis of a predetermined vehicle coordinate system, and may determine one electronic device from among the set of electronic devices on the basis of the coordinates and the space vector of the user face to be the gesture recognition object.

The controller may detect coordinates and a space vector of the user's gaze on the basis of a predetermined vehicle coordinate system, and may determine one electronic device from among the set of electronic devices on the basis of the coordinates and the space vector of the user's gaze to be the gesture recognition object.

The gesture recognition apparatus may further include: an alarm unit to indicate decision of the gesture recognition object.

In accordance with another aspect of the present disclosure, a vehicle includes: a collection unit having a single sense region, configured to collect information regarding a user gesture conducted in the sense region; and a controller to detect coordinates and a space vector of the user gesture on the basis of a predetermined vehicle coordinate system, and to determine an electronic device from among a set of electronic devices on the basis of the gesture coordinates and the space vector to be a gesture recognition object.

The predetermined vehicle coordinate system may include a coordinate system based on an internal design drawing of a vehicle.

The controller may detect the coordinates and the space vector of the user gesture with respect to the vehicle coordinate system on the basis of a position of the collection unit with respect to the vehicle coordinate system.

The controller may determine an electronic device located at an extension line of the space vector from among the set of electronic devices to be a gesture recognition object.

The vehicle may further include: an output unit to output an operation command based on the collected gesture information to the gesture recognition object.

The collected gesture information may include at least one selected from among a group consisting of hand information, finger information, and arm information of the user.

The collection unit may collect at least one of user's face information and user's gaze information.

The controller may detect coordinates and a space vector of the user face on the basis of a predetermined vehicle coordinate system, and may determine one electronic device from among the set of electronic devices to be the gesture recognition object on the basis of the coordinates and the space vector of the user face.

The controller may detect coordinates and a space vector of the user's gaze on the basis of a predetermined vehicle coordinate system, and may determine one electronic device from among the set of electronic devices to be the gesture recognition object on the basis of the coordinates and the space vector of the user's gaze.

The vehicle may further include: an alarm unit to indicate activation of the gesture recognition object.

In accordance with another aspect of the present disclosure, a method for controlling a vehicle includes: collecting information regarding a user gesture by a collection unit; detecting coordinates and a space vector of the user gesture on the basis of a predetermined vehicle coordinate system; and determining one electronic device from among a set of electronic devices to be a gesture recognition object on the basis of the gesture coordinates and the space vector.

The detection of the coordinates and the space vector of the gesture on the basis of the predetermined vehicle coordinates may include: detecting the coordinates and the space vector of the gesture with respect to the vehicle coordinate system on the basis of a position of the collection unit with respect to the vehicle coordinate system.

The determination of the electronic device from among the set of electronic devices on the basis of the gesture coordinates and the space vector may include: determining the electronic device from among the set of electronic devices to be a gesture recognition object, wherein the electronic device is located at an extension line of the space vector.

The method may further include: outputting an operation command based on the collected gesture information to the electronic device determined to be the gesture recognition object.

The method may further include: informing a user of activation of the gesture recognition object.

The determination of the gesture recognition object may include: determining a gesture recognition object on the basis of information regarding a user face. The determination of the gesture recognition object on the basis of the user face information may include: collecting user face information by a collection unit; detecting coordinates and a space vector of the user face on the basis of a predetermined vehicle coordinate system; and determining the electronic device from among the set of electronic devices to be a gesture recognition object on the basis of the coordinates and the space vector of the user face.

The determination of the gesture recognition object may include: determining a gesture recognition object on the basis of information regarding a user's gaze. The determination of the gesture recognition object on the basis of the user's gaze information may include: collecting user's gaze information by a collection unit; detecting coordinates and a space vector of the user's gaze on the basis of a predetermined vehicle coordinate system; and determining one electronic device from among the set of electronic devices to be a gesture recognition object on the basis of the coordinates and the space vector of the user's gaze.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view illustrating the appearance of a vehicle according to an embodiment of the present invention.

FIGS. 2 and 3 are views illustrating the internal structure of a vehicle according to an embodiment of the present invention.

FIG. 4 is a control block diagram illustrating a gesture recognition apparatus according to an embodiment of the present invention.

FIG. 5 is a block diagram illustrating a gesture recognition apparatus according to another embodiment of the present invention.

FIG. 6 is a block diagram illustrating a gesture recognition apparatus according to another embodiment of the present invention.

FIG. 7 is a view illustrating a sense region of a collection unit formed in a vehicle.

FIGS. 8 and 9 are views illustrating exemplary user gestures.

FIG. 10 illustrates an example for forming the vehicle coordinate system.

FIG. 11 illustrates a coordinate system of a sense region formed in the vehicle coordinate system shown in FIG. 10.

FIGS. 12 and 13 illustrate a method for detecting a space vector and coordinates of the gesture.

FIG. 14 is a conceptual diagram illustrating a method for determining a gesture recognition object on the basis of the gesture coordinates and the space vector shown in FIG. 12.

FIG. 15 is a conceptual diagram illustrating a method for determining a gesture recognition object on the basis of gesture coordinates and a space vector shown in FIG. 13.

FIG. 16 is a conceptual diagram illustrating that a lamp located in the vicinity of an audio video navigation (AVN) device is turned on.

FIG. 17 is a conceptual diagram illustrating that a lamp located in the vicinity of a display of a rear seat entertainment (RSE) system is turned on.

FIG. 18 is a conceptual diagram illustrating an exemplary method for inputting an operation command according to an embodiment of the present invention.

FIG. 19 is a flowchart illustrating a method for controlling a vehicle according to an embodiment of the present invention.

FIG. 20 is a flowchart illustrating a method for controlling a vehicle according to another embodiment of the present invention.

FIG. 21 is a flowchart illustrating a method for controlling a vehicle according to another embodiment of the present invention.

### DETAILED DESCRIPTION

Reference will now be made in detail to the embodiments of the present invention, examples of which are illustrated in the accompanying drawings, wherein like reference numerals refer to like elements throughout. A gesture recognition apparatus, a vehicle having the same, and a method for controlling the vehicle according to the embodiments will hereinafter be described with reference to the attached drawings.

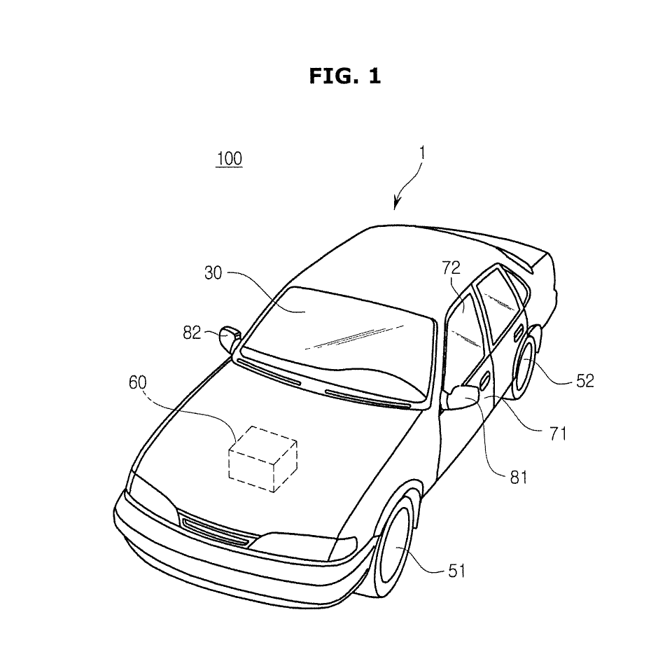

FIG. 1 is a view illustrating the appearance of a vehicle 100 according to an embodiment of the present invention.

The vehicle 100 is a mobile machine which travels on roads or tracks to carry people or cargo from place to place.

Referring to FIG. 1, the vehicle 100 according to the embodiment includes a main body 1 forming the appearance of the vehicle 100, a vehicle windshield 30 to provide a forward view of the vehicle 100 to a vehicle driver who rides in the vehicle 100, vehicle wheels (51, 52) to move the vehicle 100 from place to place, a drive unit 60 to rotate the vehicle wheels (51, 52), doors 71 to shield an indoor space of the vehicle 100 from the outside, and side-view mirrors (81, 82) to provide a rear view of the vehicle 100 to the vehicle driver.

The windshield 30 is provided at a front upper portion of the main body 100 so that a vehicle driver who rides in the vehicle 100 can obtain visual information of a forward direction of the vehicle 100. The windshield 30 may also be referred to as a windshield glass.

The wheels (51, 52) may include front wheels 51 provided at the front of the vehicle and rear wheels 52 provided at the rear of the vehicle 100. The drive unit 60 may provide rotational force to the front wheels 51 or the rear wheels 52 in a manner that the main body 1 moves forward or backward. The drive unit 60 may include an engine to generate rotational force by burning fossil fuels or a motor to generate rotational force upon receiving power from a condenser (not shown).

The doors 71 are rotatably provided at the right and left sides of the main body 1 so that a vehicle driver can get in the vehicle 100 to ride, when any of the doors 71 is open and an indoor space of the vehicle 100 can be shielded from the outside when the doors 71 are closed.

The doors 71 may be coupled to windows 72 so that a driver or passenger who rides in the vehicle can look out of the windows 72 or other people located outside of the vehicle can look into the vehicle from the outside. In accordance with the embodiment, the windows 72 may be designed in a manner that only the driver or passenger who rides in the vehicle can look out of the windows, and may also be opened or closed.

The side-view mirrors (81, 82) may include a left side-view mirror 81 provided at the left of the main body 1 and a right side-view mirror 82 provided at the right of the main body 1, so that the driver who rides in the vehicle 100 can obtain visual information of the lateral and rear directions of the vehicle 100.

Besides, the vehicle 100 may include a front camera to monitor a front-view image, and a right or left camera to monitor a lateral-view image. The vehicle 100 may include a variety of sensing devices, for example, a proximity sensor to detect the presence of obstacles located in the rear direction of the vehicle 100, a rain sensor to detect the presence or absence of rainfall and the amount of rainfall, etc.

For example, the proximity sensor may emit a sensing signal to a lateral direction or a backward direction of the vehicle 100, and receive a signal reflected from obstacles such as other vehicles. In addition, the proximity sensor may detect the presence or absence of an obstacle on the basis of a waveform of the received reflection signal, and may recognize the position of the obstacle.

The rain sensor may collect information regarding the amount of rainfall dropping on the windshield 30. For example, although the rain sensor may be implemented by any one of an optical sensor, a magnetic sensor, etc., the scope or spirit of the present disclosure is not limited thereto.

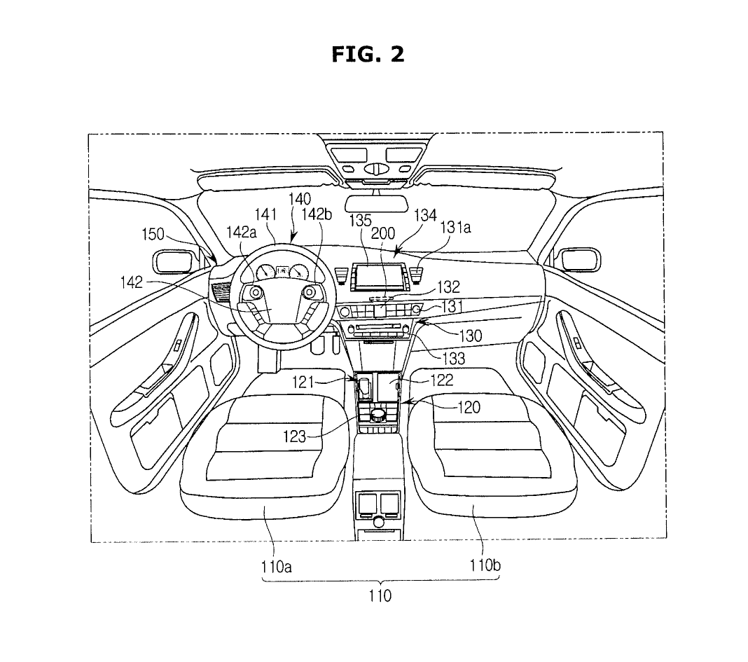

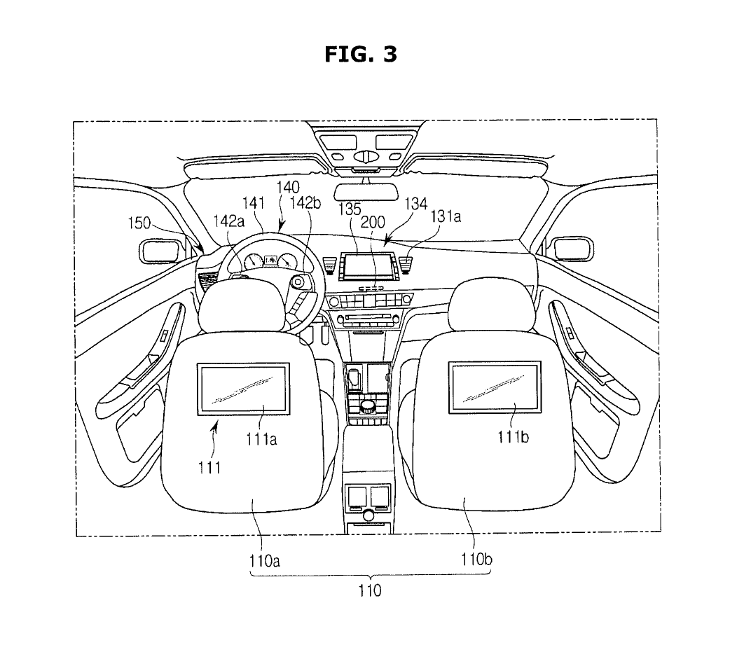

FIGS. 2 and 3 are views illustrating the internal structure of the vehicle 100 according to an embodiment of the present invention.

Referring to FIGS. 2 and 3, the vehicle may have a seat 110 on which a passenger can be seated, and a dashboard 150 including a gearbox 120, a center console (also called a center fascia) 130, a steering wheel 140, etc.

The seat 110 includes a driver seat for a driver, a passenger seat for a fellow passenger, and a rear seat arranged in the rear of the vehicle. In this case, a Rear Seat Entertainment (RSE) system may be provided at back surfaces of the driver seat and the passenger seat. The RSE system is configured to provide convenience of passengers seated on the rear seat, and may include a display mounted to the back surface of the driver seat and the passenger seat. The RSE system display may include a first display arranged at the back surface of the driver seat, and a second display arranged at the back surface of the passenger seat.

A gearshift 121 for changing gears of the vehicle 100 may be installed at the gearbox 120, and a touchpad 122 for controlling functions of the vehicle 100 may be installed in the gearbox 120. On the other hand, a dial manipulation unit 123 may be optionally installed in the gearbox 120 as necessary.

The center console 130 may include an air-conditioner 131, a clock 132, an audio device 133, the AVN device 134, etc.

The air-conditioner 131 can maintain temperature, humidity, purity, and airflow of indoor air of the vehicle 100 in a comfortable or pleasant condition. The air-conditioner 131 may be installed at the center console 130, and may include at least one air outlet 131a through which air is discharged to the outside. A button or dial for controlling the air-conditioner 131 may be installed at the center console 130. A user such as a vehicle driver may control the air-conditioner 131 of the vehicle using the button or dial mounted to the center console 130.

The clock 132 may be located in the vicinity of the button or dial for controlling the air-conditioner 131.

The audio device 133 may include a manipulation panel including a set of buttons needed to perform functions of the audio device 133. The audio device may provide a radio mode for providing a radio function and a media mode for reproducing audio files stored in various storage media.

The AVN device 134 can synthetically perform an audio function, a video function, and a navigation function according to user manipulation. The AVN device 134 may provide a radio service for reproducing a radio program on the basis of terrestrial radio signals, an audio service for reproducing a Compact Disc (CD), a digital audio file, and the like, a video service for reproducing a digital versatile disc (DVD) and the like, a navigation service for providing a navigation function, and a phone service for controlling information as to whether a mobile phone connected to the vehicle receives a phone call from another party.

The AVN device 134 may include a display 135 for providing an audio screen image, a video screen image, and a navigation screen image. The display may be implemented as a liquid crystal display (LCD) or the like.

The AVN device 134 may be installed at the top of the center console 130 as shown in FIG. 2, and may be movably or detachably mounted to the center console 130.

The steering wheel 140 is a device that adjusts a traveling direction of the vehicle 100, is connected to a rim 141 grasped by a vehicle driver and a steering device of the vehicle 100, and includes a spoke 142 to connect the rim 141 to a hub of a rotation axis for steering. In accordance with one embodiment, the spoke 142 may include various devices embedded in the vehicle 100, for example, manipulation devices (142a, 142b) for controlling the audio device, etc.

In addition, the dashboard 150 may include various instrument panels on which a vehicle traveling speed, the number of revolutions per minute (rpm) of an engine, and the remaining fuel quantity can be displayed, and may further include a glove box in which various goods can be stored.

A gesture recognition apparatus 200 for recognizing user gesture may be installed in the vehicle 100. In more detail, although the gesture recognition apparatus 200 may be embedded in a gearbox or a peripheral part of the AVN device, the installation position of the gesture recognition apparatus 200 is not limited thereto.

The gesture recognition apparatus 200 may collect information of user gestures sensed in a single sense region, and may determine a gesture recognition object on the basis of the collected gesture information. In addition, the gesture recognition apparatus may output an operation command based on gesture information to the gesture recognition object. That is, gesture information is input to a single sense region so that a set of electronic devices can be controlled by the input gesture.

In the embodiments of the present invention, user gesture information may conceptually include at least one selected from a group consisting of the movement of a user's hand, the movement of a user's finger, and the movement of a user's arm. In more detail, the user gesture information may include information regarding the direction and position of a hand, finger, or arm of the user.

The gesture recognition apparatus 200 will hereinafter be described in detail.

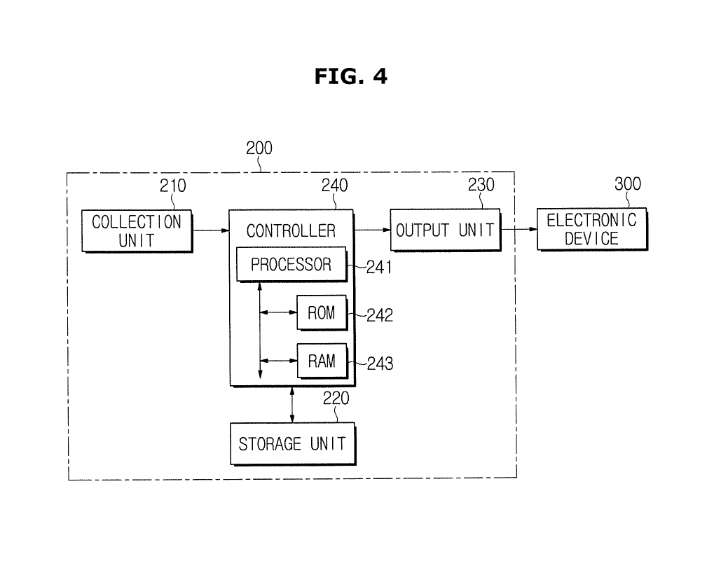

FIG. 4 is a control block diagram illustrating a gesture recognition apparatus 200 according to an embodiment of the present invention.

Referring to FIG. 4, the gesture recognition apparatus 200 may include a collection unit 210, a storage unit 220, an output unit 230, and a controller 240.

The collection unit 210 may collect information of various user gestures conducted in a sense region formed in the vicinity of the gesture recognition apparatus 200. In more detail, the collection unit 210 may have a single sense region, may collect information of user gestures conducted in the single sense region, and may output the collected information to the controller 240.

The collection unit 210 may include an image collector to collect images of a user gestures. In this case, the image collector may be a single camera, two cameras or a three-dimensional (3D) camera to collect object images at different positions.

The collection unit 210 may include a capacitive sensor to detect capacitance of a target object, an ultrasound sensor to detect a distance to the target object, or a photo sensor to detect light reflected from the target object. The collection unit 210 may also include a set of gesture collection units well known to those skilled in the art.

The storage unit 220 may store various data and programs to drive/control the gesture recognition apparatus 200 according to a control signal of the controller 240. In more detail, the storage unit 220 may store operation commands of the set of electronic devices 300, and may store information of a user gesture corresponding to any one of the operation commands.

The set of electronic devices 300 may include an RSE system 111 for providing convenience to a passenger seated on a rear seat of the vehicle; an air-conditioner 131 for adjusting indoor air of the vehicle 100; an audio device 133 for playing radio or music files; a navigation device 134 for navigating to a destination; a Bluetooth device (not shown) to communicate with an external terminal device; a heater (not shown) for heating vehicle seats; a windshield glass opening/closing unit (not shown) to automatically open or close the windshield glass; a sunroof opening/closing unit (not shown) to automatically open or close the sunroof; a door opening/closing unit to automatically open or close front, rear, left and right doors; and a door lock device (not shown) to lock or release the front, rear, left and right doors.

The storage unit 220 may store operation commands of electronic devices 300 in response to one gesture of a user.

The storage unit 220 may also be referred to as conceptually including a memory card (e.g., micro SD card, USB memory, etc.) mounted to the gesture recognition apparatus 200. In addition, the storage unit 220 may include a non-volatile memory, a volatile memory, a hard disc drive (HDD) or a solid state drive (SSD). In addition, the storage unit 220 may conceptually include a ROM 242 and a RAM 243 of the controller 240.

The output unit 230 is connected to each of the electronic devices 300, so that it may output an operation command to at least one electronic device 300. If at least one of the set of electronic devices 300 is determined to be a gesture recognition object, the output unit 230 may output the operation command based on gesture information to the electronic device 300 indicating the gesture recognition object according to a control signal of the controller 240.

The output unit 230 may include a digital port, an analog port, etc. connected to the set of electronic devices 300. In addition, the output unit 230 may include Controller Area Network (CAN) communication to communicate with the set of electronic devices 300.

The controller 240 may include a processor 241, a ROM 242 that stores a control program 243 for controlling the gesture recognition apparatus 200, and a RAM 243 that stores user gesture information collected from an external part of the gesture recognition apparatus 200 or be used as a storage region corresponding to various tasks.

The controller 240 may control overall operations of the gesture recognition apparatus 200 and the signal flow among internal constituent elements of the gesture recognition apparatus 200, and may perform data processing among the internal constituent elements of the gesture recognition apparatus 200.

The controller 240 may detect coordinates of a user gesture and the space vector on the basis of a predetermined vehicle coordinate system, and may determine a gesture recognition object on the basis of the coordinates and the space vector of the gesture.

If the coordinates of the gesture and the space vector for the vehicle coordinate system are detected, the controller 240 may determine a specific electronic device 300, which is located at an extension line of the space vector from among the set of electronic devices 300, to be a gesture recognition object.

If the gesture recognition object is decided, the controller 240 may control the output unit 230 to output an operation command corresponding to gesture information to the electronic device 300 indicating the gesture recognition object. A detailed description thereof will be given below.

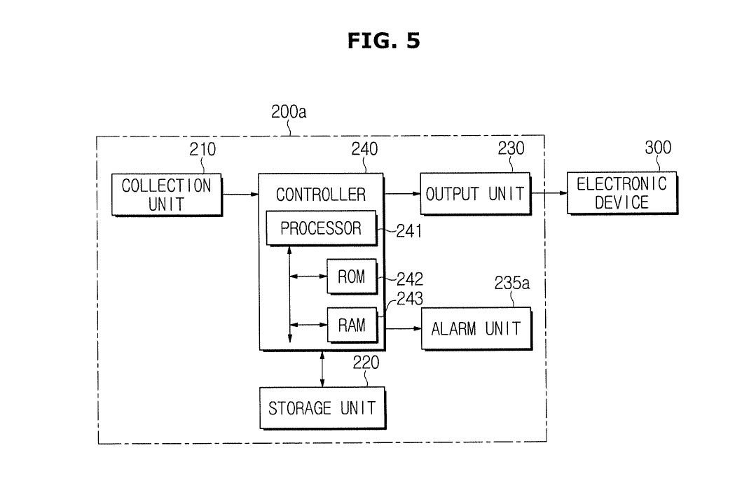

FIG. 5 is a block diagram illustrating a gesture recognition apparatus 200a according to another embodiment of the present invention.

Referring to FIG. 5, the gesture recognition apparatus 200a according to the embodiment may include a collection unit 210, a storage unit 220, an output unit 230, an alarm unit 235a, and a controller 240. Since the gesture recognition apparatus 200a of FIG. 5 further includes the alarm unit 235a, there is a difference between the gesture recognition apparatus 200a of FIG. 5 and the gesture recognition apparatus 200 of FIG. 4. Detailed operations of the gesture recognition apparatus 200a will hereinafter be described with reference to the above difference between the gesture recognition apparatus of FIG. 4 and the gesture recognition apparatus of FIG. 5.

The alarm unit 235a may be formed as a lamp arranged in the vicinity of the electronic devices 300. In accordance with the embodiment, the alarm unit 235a may audibly provide a warning message. The alarm unit 235a may inform the user of one electronic device 300 determined to be a gesture recognition object, so that the user can easily recognize the gesture recognition object.

For example, assuming that the AVN device 134 is determined to be a gesture recognition object by the user gesture, the lamp installed in the vicinity of the AVN device 134 may be turned on in such a manner that the user can perform a control operation appropriate for the gesture recognition object, or a color of the lamp may be changed to another color. In accordance with the embodiment, the fact that the AVN device 134 is determined to be the gesture recognition object may be audibly provided as a voice signal as necessary.

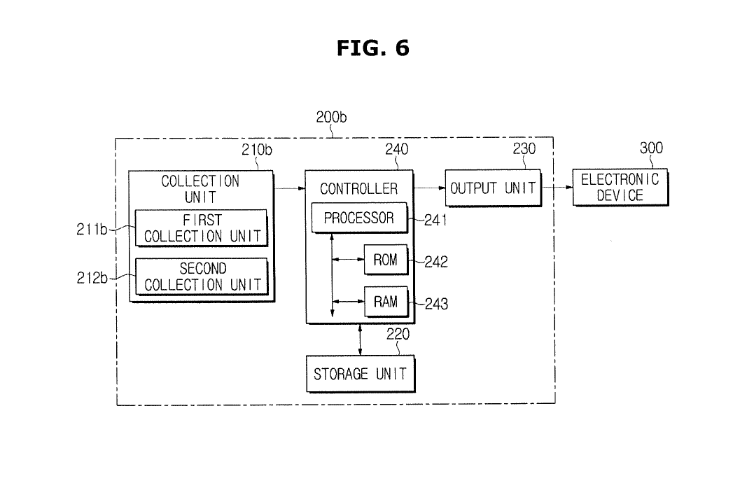

FIG. 6 is a block diagram illustrating a gesture recognition apparatus 200b according to another embodiment of the present invention.

Referring to FIG. 6, the gesture recognition apparatus 200b according to another embodiment includes a collection unit 210b, a storage unit 220, an output unit 230, and a controller 240. The collection unit 210b may include a first collection unit 211b and a second collection unit 212b. The collection unit 210b of the gesture recognition apparatus 200b shown in FIG. 6 has a different structure than the gesture recognition apparatus 200 shown in FIG. 4. Detailed operations of the gesture recognition apparatus 200b will hereinafter be described with reference to the above difference between the gesture recognition apparatus of FIG. 6 and the gesture recognition apparatus of FIG. 4.

The gesture recognition apparatus 200 according to the embodiment may include a first collection unit 211b and a second collection unit 212b. The second collection unit 212b may function as an auxiliary collector of the first collection unit 211b. The first collection unit 211b and the second collection unit 212b are named as such only to discriminate between the set of collection units (210, 210b), and the first collection unit 211b may function as an auxiliary collector of the second collection unit 212b. The following description assumes that the second collection unit 212b serves as an auxiliary collector of the first collection unit 211b.

The first collection unit 211b may collect information of user gestures conducted in the sense region. In more detail, the first collection unit 211b may have a single sense region, may collect information regarding user gestures conducted in the single sense region, and may output the collected information to the controller 240.

The second collection unit 212b may collect at least one of information regarding the user's face or information regarding the user's gaze. In more detail, if it is difficult to recognize user's intention by only using the user gesture according to a traveling situation of the vehicle 100, the gesture recognition object can be determined through the user face information or the user's gaze information collected through the second collection unit 212b. In this case, the user's gaze information may conceptually include information regarding a user's eye pupil position.

The second collection unit 212b may include an image collector to collect images of a user's face or images of user's eyes. In this case, the image collector may be a single camera, two cameras or a three-dimensional (3D) camera to collect the images of user's face or the images of user's eyes at different positions.

The controller 240 may detect the coordinates and the space vector of the user's face on the basis of a predetermined vehicle coordinate system, and may determine a gesture recognition object on the basis of the coordinates and the space vector of the user's face. In more detail, the controller 240 may detect the coordinates and the space vector of a user's face with respect to the vehicle coordinate system upon receiving the position of the second collection unit 212b for the vehicle coordinate system, and may determine the electronic device 300 located at an extension line of the space vector to be a gesture recognition object on the basis of the coordinates and the space vector of the user's face.

In the same manner, the controller 240 may detect the coordinates and the space vector of user's eyes on the basis of a predetermined vehicle coordinate system, and may determine the gesture recognition object on the basis of the coordinates and the space vector of user's eyes. In more detail, the controller 240 may detect the coordinates and the space vector of user's eyes with respect to the vehicle coordinate system upon receiving the position of the second collection unit 212b for the vehicle coordinate system, and may determine the electronic device 300 located at an extension line of the space vector to be a gesture recognition object on the basis of the coordinates and the space vector of the user's eyes.

The gesture recognition apparatus 200, according to the embodiment, can more clearly recognize the user intention simultaneously using the user's face recognition scheme and the user's gaze recognition scheme. In contrast, the user's face recognition scheme and the user's gaze recognition scheme can be used as auxiliary forms of the gesture recognition scheme as described above. In accordance with the embodiment, the user's face recognition scheme and the user's gaze recognition scheme may be simultaneously applied or any one thereof may also be applied thereto.

Control block diagrams of the gesture recognition apparatuses (200, 200a, 200b) have been disclosed. The vehicle 100 according to the embodiments may include the above-mentioned gesture recognition apparatuses (200, 200a, 200b) without change, and additional control block diagrams of the vehicle 100 will herein be omitted for convenience of description and better understanding of the features.

The principles and the operation command output example of a user-desired electronic device 300 from among the set of electronic devices 300 will hereinafter be described in detail.

The principles of the user-desired electronic device 300 will hereinafter be described.

The gesture recognition apparatus 200 according to one embodiment collects user gesture information through the collection unit 210, detects the coordinates and the space vector of user gesture on the basis of a predetermined vehicle coordinate system, and determines a gesture recognition object on the basis of the coordinates and the space vector of the gesture.

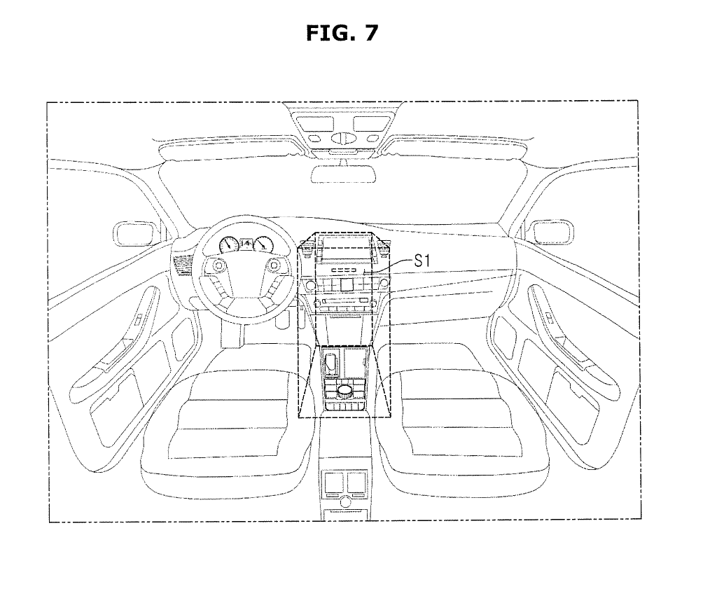

The user may input gesture information to the sense region formed in the vicinity of the collection unit 210. FIG. 7 is a view illustrating a sense region S1 of a collection unit 210 formed in the vehicle 100.

Referring to FIG. 7, a single sense region S1 may be formed in the vicinity of the collection unit 210 of the gesture recognition apparatus 200. The user may control various electronic devices 300 by inputting a gesture to the single sense region S1. Although FIG. 7 shows an exemplary case in which the sense region S1 is formed between a driver seat and a passenger seat, the formation example of the sense region S1 is not limited thereto.

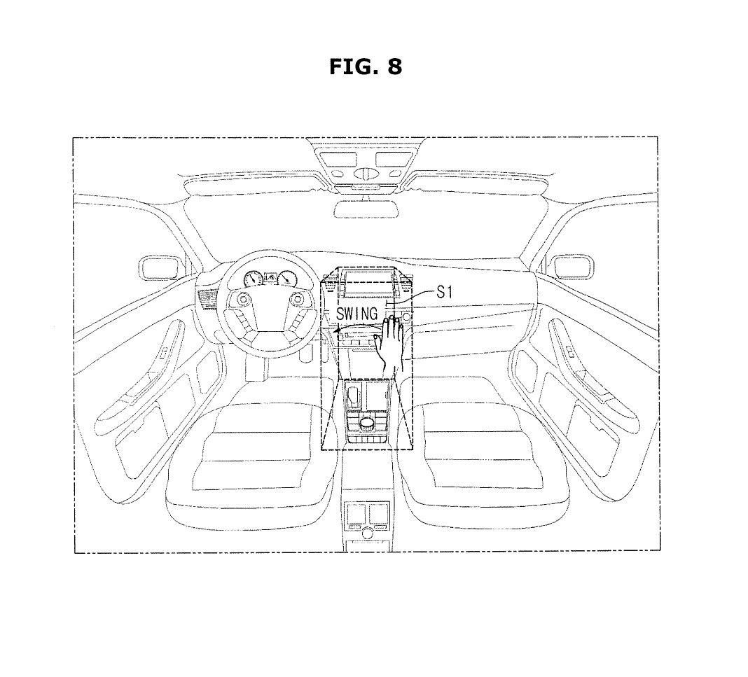

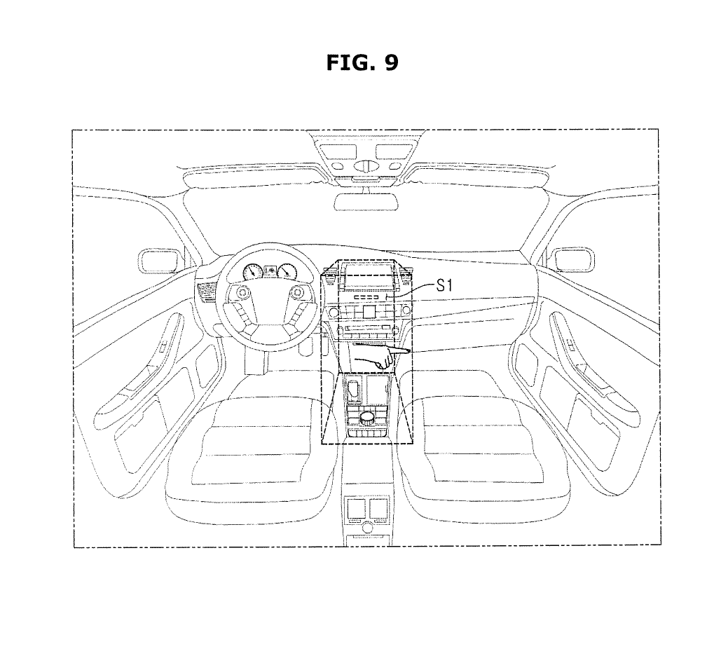

FIGS. 8 and 9 are views illustrating exemplary user gestures.

Referring to FIG. 8, a user may input a specific gesture that the user points to a specific electronic device 300 and swings in one direction. The collection unit 210 may collect the user gesture information, and may transmit the collected gesture information to the controller 240.

Referring to FIG. 9, a user may also input a gesture that the user points to a specific electronic device 300. The collection unit 210 may collect the above-mentioned user gesture information, and may transmit the collected gesture information to the controller 240.

If the user gesture information is collected, the controller 240 may detect the coordinates and the space vector of the gesture on the basis of a predetermined vehicle coordinate system. In accordance with the embodiment, the controller 240 may detect the coordinates and the space vector of the gesture for the vehicle coordinate system on the basis of the position of the collection unit 210 with respect to the vehicle coordinate system. In this case, the vehicle coordinate system may be a coordinate system based on the internal design of the vehicle 100.

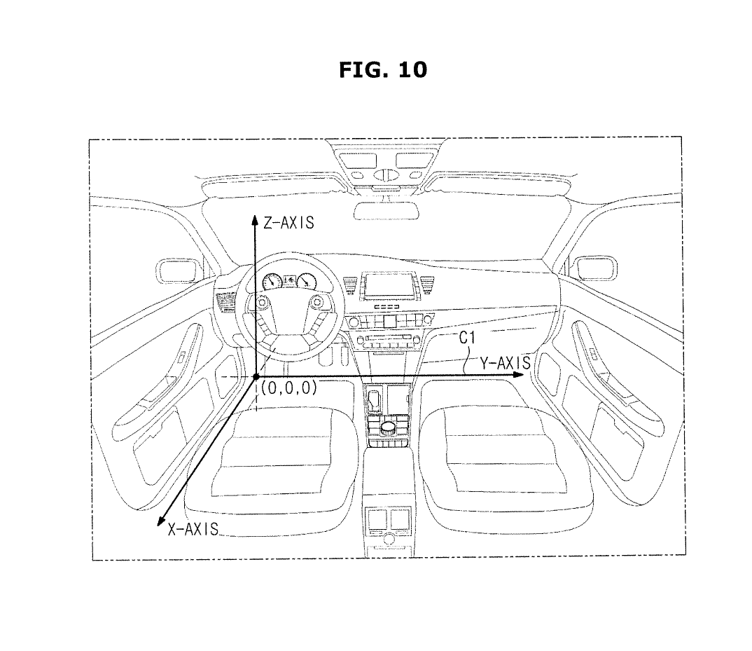

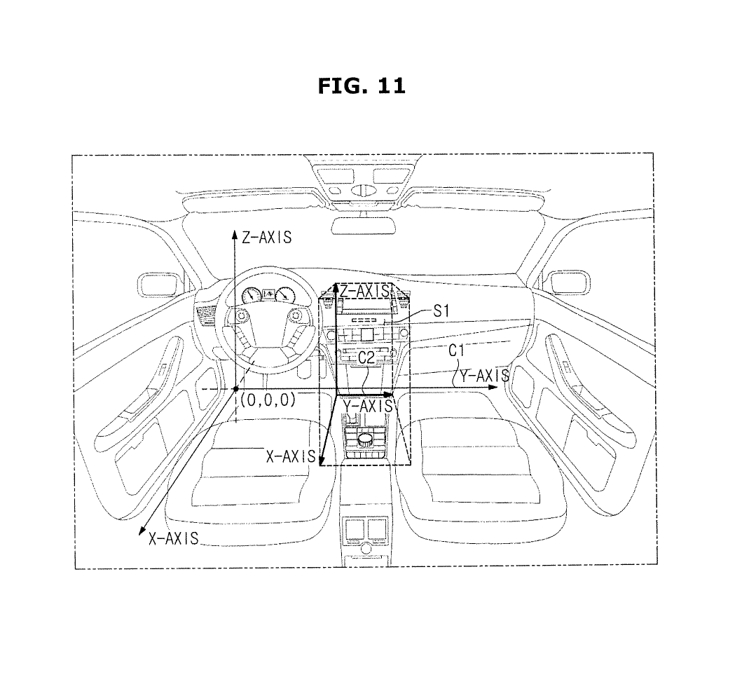

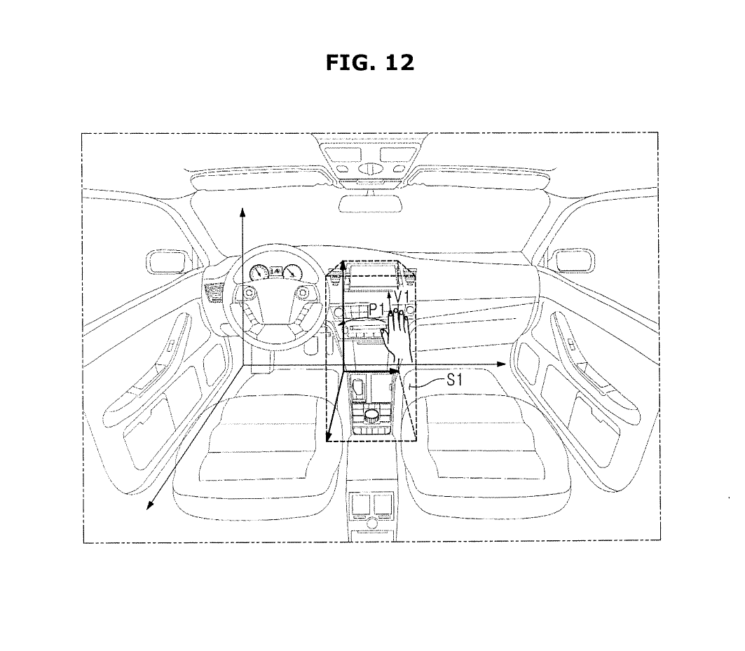

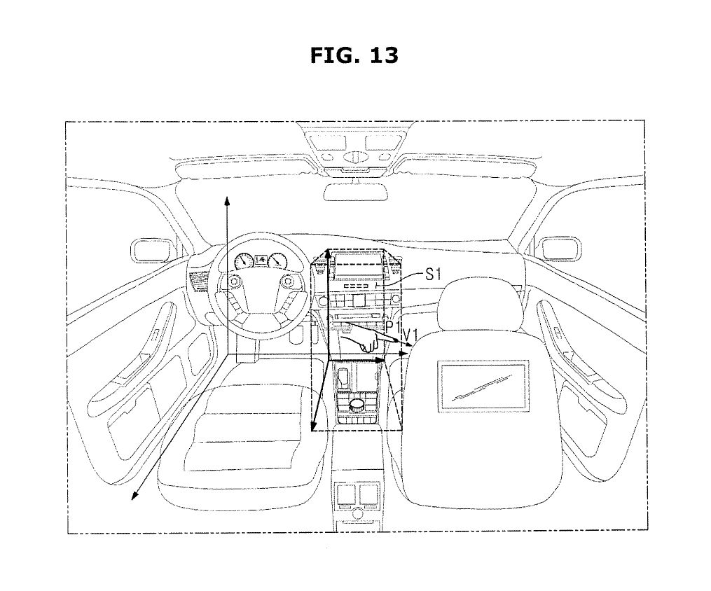

FIG. 10 illustrates an example for forming a vehicle coordinate system C1. FIG. 11 illustrates a coordinate system C2 of the sense region S1 formed in the vehicle coordinate system C1 shown in FIG. 10. FIGS. 12 and 13 illustrate methods for detecting the space vector and coordinates of the gesture.

The vehicle coordinate system C1 may be configured as shown in FIG. 10. The vehicle coordinate system C1 may be based on a predetermined drawing needed for the internal design of the vehicle 100, and the electronic device 300 contained in the vehicle 100 may be disposed at the coordinate system shown in FIG. 10. In accordance with the embodiment, the AVN device 134 may be defined as (x1, y1) on the vehicle coordinate system C1, the display provided at the back surface of the passenger seat may be defined as (x2, y2) on the vehicle coordinate system C1, and the display provided at the surface of the RSE system 111 may be defined as (x3, y3).

The coordinate system C2 of the sense region S1 may be provided at a specific point on the vehicle coordinate system C1 as shown in FIG. 11. Information regarding a relative position of the sense region coordinate system C2 with respect to the vehicle coordinate system C1 may be pre-stored, and the coordinates on the sense region coordinate system C2 may be converted into coordinates on the vehicle coordinate system C1.

If user gesture is input to the sense region coordinate system C2, the coordinates and the space vector of the gesture may be detected.

Referring to FIGS. 12 and 13, the gesture recognition apparatus 200 according to the embodiment may detect a specific point corresponding to the forefinger-tip of a user's hand as gesture coordinates P1. A direction of the forefinger-tip of user's hand may be detected as a space vector V1 of the gesture.

In FIGS. 12 and 13, although the forefinger-tip position of the user's hand is detected as the gesture coordinates P1, and the direction indicated by the user's forefinger is detected as the gesture space vector V1 for convenience of description and better understanding of the present disclosure, the scope or spirit of the disclosure is not limited thereto. The center part of a palm of a user hand may be recognized as the coordinates of the gesture, and the direction pointed by the palm may also be detected as the space vector.

The coordinates P1 of the user gesture detected on the sense region coordinates C2 and the space vector V1 of the user gesture may be converted into the coordinates P1a of the vehicle coordinate system C1 and the space vector V1a. In the above process, the position information of the sense region coordinates C2 with respect to the pre-stored vehicle coordinate system C1 may be provided to the storage unit 220.

If the gesture coordinates P1a of the vehicle coordinate system C1 and the gesture space vector V1a are detected, the controller 240 may determine the electronic device 300 located at an extension line of the gesture space vector V1a from among the set of electronic devices 300 to be a gesture recognition object.

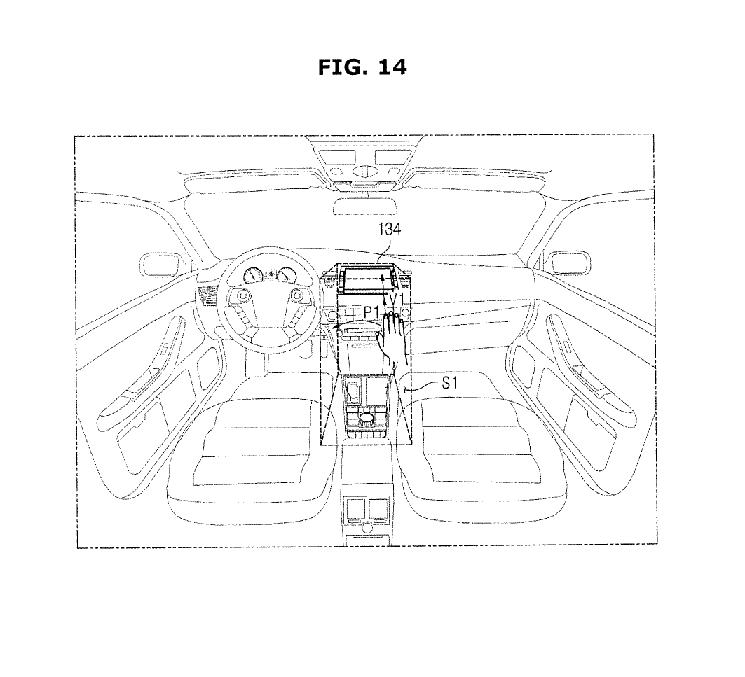

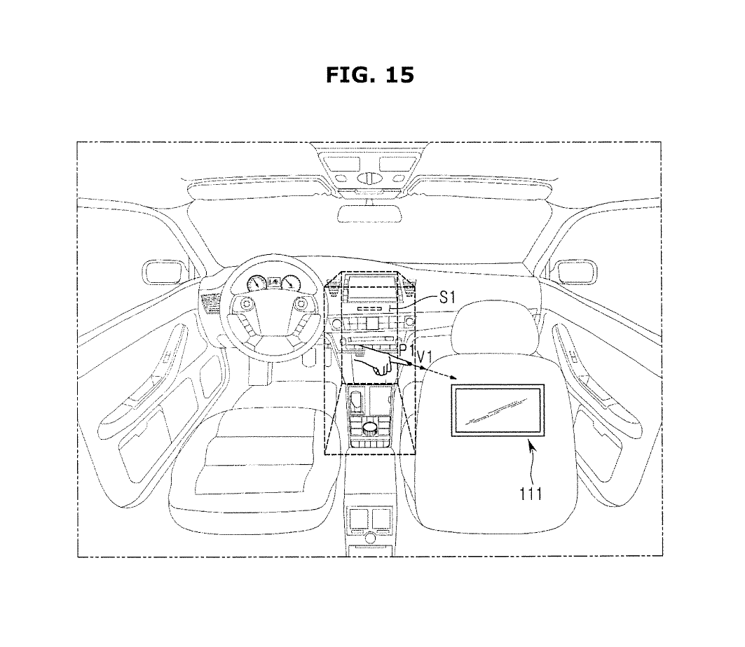

FIG. 14 is a conceptual diagram illustrating a method for determining a gesture recognition object on the basis of the gesture coordinates P1 and the space vector V1 shown in FIG. 12. FIG. 15 is a conceptual diagram illustrating a method for determining a gesture recognition object on the basis of gesture coordinates P1 and a space vector V1 shown in FIG. 13.

If the coordinates P1 and the space vector V1 with respect to the vehicle coordinate system C1 are detected, the electronic device 300 located at an extension line of the space vector V1 may be determined to be a gesture recognition object as shown in FIG. 14. In FIG. 14, the AVN device 134 located at an extension line of the direction pointed to by the user's forefinger-tip may be determined to be a gesture recognition object. In FIG. 15, the RSE system 111 located at an extension line of the direction pointed to by the user's forefinger-tip may be determined to be a gesture recognition object.

If the gesture recognition object is determined, an alarm message may be provided to the user.

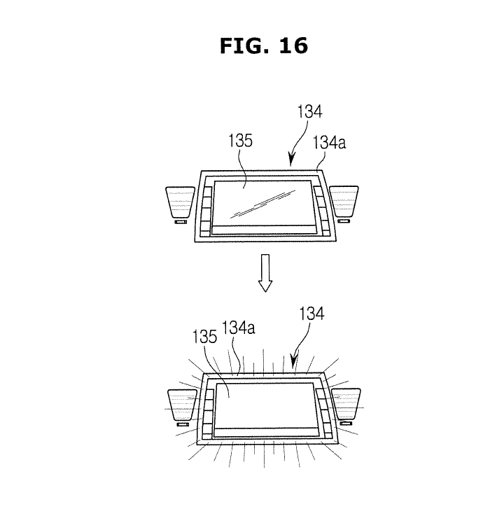

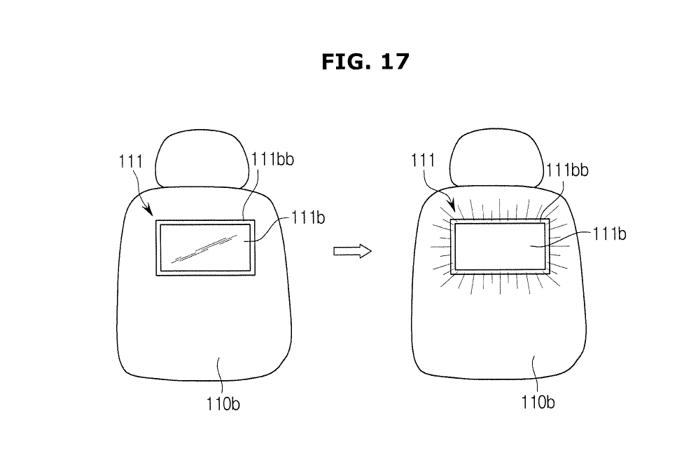

FIG. 16 is a conceptual diagram illustrating that a lamp 134a located in the vicinity of an audio video navigation (AVN) device 134 is turned on. FIG. 17 is a conceptual diagram illustrating an exemplary method for turning on a lamp 111bb located in the vicinity of a display 111b of a rear seat entertainment (RSE) system 111.

Referring to FIG. 16, the lamp 134a may be arranged in the vicinity of the display 135 of the AVN device 134. The lamp 134a may inform the user of the fact that the AVN device 134 is determined to be the gesture recognition object, so that the fact can be fed back to the user through the lamp 134a. If the AVN device 134 is determined to be the gesture recognition object, the AVN device 134 may be turned on. In accordance with the embodiment, a voice signal indicating that the AVN device 134 is determined to be the gesture recognition object may also be generated or may be generated independently.

Referring to FIG. 17, the lamp 111bb may be arranged in the vicinity of the display 111b of the RSE system 111 located at a back surface of the passenger seat 110b. The lamp 111bb may inform the user of the fact that the RSE system 111 is activated, so that the fact can be fed back to the user through the lamp 111bb. If the RSE system 111 is activated, the RSE system 111 may be turned on. In accordance with the embodiment, an additional lamp of the RSE system 111 may be provided at a front surface of the center console 130 in such a manner that a vehicle driver can easily recognize that the RSE system 111 is activated, and a voice signal indicating activation of the RSE system 111 may also be provided to the vehicle driver.

If the gesture recognition object is determined, the output unit 230 may output the operation command of the electronic device 300. If the operation command output for the electronic device 300 may be performed simultaneously with the determination process of the gesture recognition object, and may also be carried out according to information separately entered by the user. For example, if the user inputs the swing gesture as shown in FIG. 8, the gesture recognition object is determined and at the same time the operation command of the electronic device 300 may be generated. In contrast, if the user inputs a gesture pointing to a specific electronic device 300 as shown in FIG. 9, the determination of the gesture recognition object is made and at the same time the operation command of the continuously-entered user gesture may be generated.

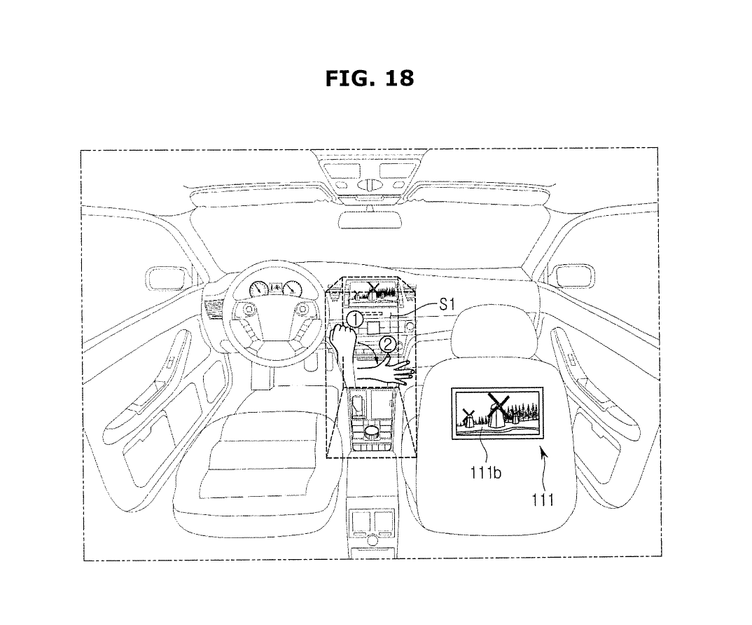

FIG. 18 is a conceptual diagram illustrating an exemplary method for inputting an operation command according to an embodiment of the present invention.

Referring to FIG. 18, if the RSE system 111 is determined to be the gesture recognition object, the user may output a control command of the RSE system 111.

For example, the user inputs a specific gesture in which the user grasps one part from among the sense region S1 and throws the grasped part to the direction of the display 111b of the RSE system 111, so that the screen image displayed on the display 135 of the AVN device 134 may be applied to the display 111b of the RSE system 111.

A method for controlling the vehicle 100 according to the embodiment will hereinafter be described in detail.

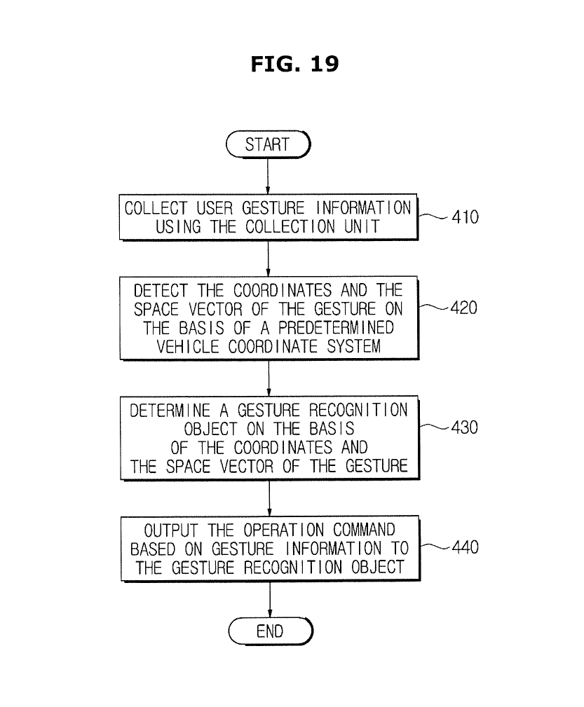

FIG. 19 is a flowchart illustrating a method for controlling a vehicle according to an embodiment of the present invention.

Referring to FIG. 19, a method for controlling the vehicle according to the embodiment includes an operation 410 in which a collection unit 210 collects user gesture information, an operation 420 in which the coordinates and the space vector of the gesture are detected on the basis of a predetermined vehicle coordinate system, an operation 430 in which the gesture recognition object is determined on the basis of the coordinates and the space vector of the gesture, and an operation 440 in which the operation command based on gesture information is output to the gesture recognition object.

At step 410, the collection unit 210 collects information regarding the user gesture conducted in the sense region S1. If the user gesture is input to the sense region S1, the collection unit 210 may output the user gesture information to the controller 240.

If the controller 240 receives the user gesture information from the collection unit 210, the coordinates and the space vector of the gesture can be detected on the basis of a predetermined vehicle coordinate system C1 in operation 420. The step 420 in which the coordinates and the space vector of the gesture are detected on the basis of the predetermined vehicle coordinate system C1, may include detecting the coordinates and the space vector of the gesture with respect to the vehicle coordinate system C1 on the basis of the position of the collection unit 210 for the vehicle coordinate system C1.

If the coordinates and the space vector of the gesture are detected, the gesture recognition object may be determined on the basis of the coordinates and the space vector of the gesture in operation 430. The step 430 in which the gesture recognition object is determined on the basis of the coordinates and the space vector of the gesture, may include determining an electronic device 300 located at an extension line of the space vector from among the set of electronic devices 300 to be a gesture recognition object.

If the gesture recognition object is determined, the operation command based on the gesture information may be output to the gesture recognition object at step 440. The operation command based on the gesture information may be pre-stored in the storage unit 220. The controller 240 may output the operation command based on gesture information to the storage unit 220 on the basis of the operation command information based on the pre-stored gesture information.

By a single gesture input action of the user, the process for determining the gesture recognition object and the process for outputting the operation command may be simultaneously or sequentially carried out. In accordance with the embodiment, the process for determining the gesture recognition object by a first input gesture of the user may be carried out, and the process for outputting the operation command may then be carried out by the next gesture of the user.

A method for controlling the vehicle according to another embodiment will hereinafter be described in detail.

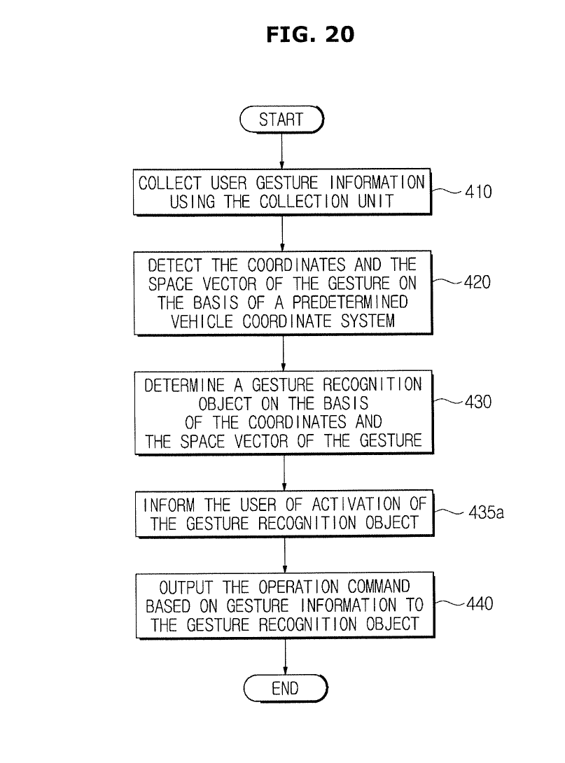

FIG. 20 is a flowchart illustrating a method for controlling a vehicle according to another embodiment of the present invention.

Referring to FIG. 20, the method for controlling the vehicle according to another embodiment of the present invention includes an operation 410 in which a collection unit 210 collects user gesture information, an operation 420 in which the coordinates and the space vector of the gesture are detected on the basis of a predetermined vehicle coordinate system, an operation 430 in which the gesture recognition object is determined on the basis of the coordinates and the space vector of the gesture, an operation 435a in which the gesture recognition object is activated, and an operation 440 in which the operation command based on gesture information is output to the gesture recognition object. That is, the method for controlling the vehicle 100 shown in FIG. 20 further includes the operation 435a in which the user is notified of information indicating activation of the gesture recognition object, differently from the method for controlling the vehicle 100 shown in FIG. 19.

The method for controlling the vehicle according to the embodiment may further include the step 435a in which, if the gesture recognition object is determined, information indicating activation of the gesture recognition object may be applied to the user. In accordance with the embodiment, a user gesture indicating one electronic device 300 from among the set of electronic device 300 may be input. In this case, there is a need to additionally input an additional gesture for outputting the operation command to the gesture recognition object. In this case, an alarm message is provided to the user according to the method for controlling the vehicle 100, resulting in greater convenience of the user. In association with the method for providing an alarm message, the same description as in the above-mentioned description will herein be omitted for convenience and description.

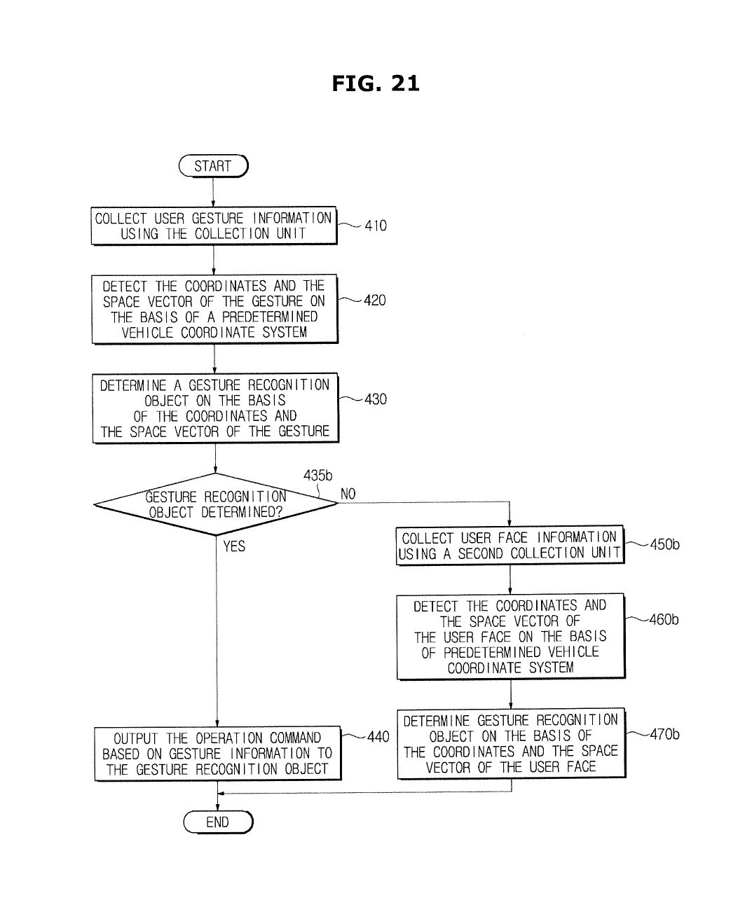

A method for controlling the vehicle according to another embodiment will hereinafter be described with reference to FIG. 21.

FIG. 21 is a flowchart illustrating a method for controlling a vehicle according to another embodiment of the present invention.

Referring to FIG. 21, the method for controlling the vehicle according to another embodiment includes a step 410 in which a first collection unit 211b collects user gesture information, a step 420 in which the coordinates and the space vector of the gesture are detected on the basis of a predetermined vehicle coordinate system, a step 430 in which the gesture recognition object is determined on the basis of the coordinates and the space vector of the gesture, and steps (435b, 440) in which, if the gesture recognition object is determined, the operation command based on gesture information is applied to the gesture recognition object.

In contrast, if the gesture recognition object is not determined, the second collection unit 212b collects the user face information at step 450b. The coordinates and the space vector of the user face are determined on the basis of a predetermined vehicle coordinate system C1 at step 460b. A gesture recognition object may be determined on the basis of the coordinates and the space vector of the user face at step 470b.

That is, the method for controlling the vehicle according to the embodiment includes an algorithm for determining the gesture recognition object using the second collection unit 212b, differently from the vehicle control method of FIG. 19. The vehicle control method shown in FIG. 21 will hereinafter be described centering on the difference between FIG. 21 and FIG. 19.

If, at step 435b, it is determined that the gesture recognition object is not determined on the basis of information of the user gesture input to the first collection unit 211b, the second collection unit 212b may collect the user face information at step 450b.

The vehicle control method according to this embodiment aims to implement a method for correctly deciding the gesture recognition object. Due to various external stimuli during the traveling of the vehicle 100, it may be difficult for the first collection unit 211b to determine a gesture recognition object only using user gesture information collected by the first collection unit 211b. In this case, the gesture recognition object is determined by collecting user face information, so that the user intention can be more clearly recognized.

For example, the air-conditioner 131 and the AVN device 134 are located adjacent to each other. If the vehicle 100 excessively shakes or if the user is driving the vehicle 100, it may be difficult to recognize whether the user gesture aims to control the air-conditioner 131 or the AVN device 134. In this case, if the user points out the AVN device 134 with a nod of a user head, this means that the AVN device 134 is controlled so that the user intention is more clearly reflected to determine the gesture recognition object.

The second collection unit 212b may collect the user face information, and may output the collected information to the controller 240.

Upon receiving the user face information from the second collection unit 212b, the controller 240 may detect the coordinates and the space vector of the user face on the basis of the vehicle coordinate system C1 in operation 460b. The operation 460b for detecting the coordinates and the space vector of the user face on the basis of the predetermined vehicle coordinate system C1 may include detecting the coordinates and the space vector of the user face with respect to the vehicle coordinate system C1 on the basis of the position of the second collection unit 212b for the vehicle coordinate system C1. For example, the tip of a nose of the user face may be set to the coordinates of the user face, and the forward direction of the user face may be determined to be the direction of the space vector. However, the scope or spirit of the present disclosure is not limited thereto.

If the coordinates and the space vector of the user face are detected, the operation for determining the gesture recognition object on the basis of the detected coordinates and space vector may be performed in operation 470b. The operation for determining the gesture recognition object on the basis of the coordinates and the space vector of the user face may include determining the electronic device 300 located at an extension line of the space vector from among the set of electronic devices 300 to be a gesture recognition object.

In accordance with the embodiment, the second collection unit 212b may collect information regarding the user face and information regarding the user's gaze, and the same description as in the above-mentioned description in association with the method for utilizing the user's gaze information will herein be omitted for convenience and description.

The gesture recognition apparatuses (200, 200a, 200b), the vehicle 100 having the same, and the method for controlling the vehicle 100 according to the embodiments have been disclosed for illustrative purposes only. It will be apparent to those skilled in the art that various modifications and variations can be made without departing from the spirit or scope of the present disclosure. Therefore, the above-mentioned detailed description must be considered only for illustrative purposes instead of restrictive purposes. The scope of the present disclosure must be decided by a rational analysis of the claims, and modifications within equivalent ranges of the present disclosure are within the scope of the present disclosure.

As is apparent from the above description, a gesture recognition apparatus, a vehicle having the same, and a method for controlling the vehicle according to one embodiment can recognize a user gesture being input to a single sense region so as to control a set of electronic devices according to the recognized result.

A gesture recognition apparatus, a vehicle having the same, and a method for controlling the vehicle according to another embodiment can more definitely recognize user intention, thereby deciding a gesture recognition object.

Although a few embodiments of the present invention have been shown and described, it would be appreciated by those skilled in the art that changes may be made in these embodiments without departing from the principles and spirit of the disclosure, the scope of which is defined in the claims and their equivalents.

What is claimed is:

1. A gesture recognition apparatus comprising:
a collection unit having a single sense region, configured to collect information regarding a user gesture conducted in the sense region; and
a controller to:
detect coordinates and a space vector of the user gesture on the basis of a predetermined vehicle coordinate system, and
determine an electronic device from among a plurality of electronic devices on the basis of the gesture coordinates and the space vector to be a gesture recognition object.

2. The gesture recognition apparatus according to claim 1, wherein the predetermined vehicle coordinate system includes a coordinate system based on an internal design drawing of a vehicle.

3. The gesture recognition apparatus according to claim 1, wherein the controller detects the coordinates and the space vector of the user gesture with respect to the vehicle coordinate system on the basis of a position of the collection unit with respect to the vehicle coordinate system.

4. The gesture recognition apparatus according to claim 1, wherein the controller determines an electronic device located at an extension line of the space vector from among the plurality of electronic devices to be a gesture recognition object.

5. The gesture recognition apparatus according to claim 1, further comprising:
an output unit configured to output an operation command based on the collected gesture information to the gesture recognition object.

6. The gesture recognition apparatus according to claim 1, wherein the collected gesture information includes at least one of hand information, finger information, and arm information of the user.

7. The gesture recognition apparatus according to claim 1, wherein the collection unit includes:
an image collection unit configured to collect an image of the user gesture so as to recognize the gesture.

8. The gesture recognition apparatus according to claim 1, wherein the collection unit includes:
a photo sensor to receive light reflected from the user gesture.

9. The gesture recognition apparatus according to claim 1, wherein the collection unit collects at least one of user's face information and user's gaze information.

10. The gesture recognition apparatus according to claim 9, wherein the controller detects coordinates and a space vector of the user face on the basis of a predetermined vehicle coordinate system, and determines one electronic device from among the plurality of electronic devices on the basis of the coordinates and the space vector of the user face to be the gesture recognition object.

11. The gesture recognition apparatus according to claim 9, wherein the controller detects coordinates and a space vector of the user's gaze on the basis of a predetermined vehicle coordinate system, and determines one electronic device from among the plurality of electronic devices on the basis of the coordinates and the space vector of the user's gaze to be the gesture recognition object.

12. The gesture recognition apparatus according to claim 1, further comprising:
an alarm unit to indicate decision of the gesture recognition object.

13. A vehicle comprising:
a collection unit having a single sense region, configured to collect information regarding a user gesture conducted in the sense region; and
a controller to:
detect coordinates and a space vector of the user gesture on the basis of a predetermined vehicle coordinate system, and
determine an electronic device from among a plurality of electronic devices on the basis of the gesture coordinates and the space vector to be a gesture recognition object.

14. The vehicle according to claim 13, wherein the predetermined vehicle coordinate system includes a coordinate system based on an internal design drawing of a vehicle.

15. The vehicle according to claim 13, wherein the controller detects the coordinates and the space vector of the user gesture with respect to the vehicle coordinate system on the basis of a position of the collection unit with respect to the vehicle coordinate system.

16. The vehicle according to claim 13, wherein the controller determines an electronic device located at an extension line of the space vector from among the plurality of electronic devices to be the gesture recognition object.

17. The vehicle according to claim 13, further comprising:
an output unit to output an operation command based on the collected gesture information to the gesture recognition object.

18. The vehicle according to claim 13, wherein the collected gesture information includes at least one of hand information, finger information, and arm information of the user.

19. The vehicle according to claim 13, wherein the collection unit collects at least one of user's face information and user's gaze information.

20. The vehicle according to claim 19, wherein the controller detects coordinates and a space vector of the user face on the basis of a predetermined vehicle coordinate system, and determines one electronic device from among the plurality of electronic devices to be the gesture recognition object on the basis of the coordinates and the space vector of the user face.

21. The vehicle according to claim 19, wherein the controller detects coordinates and a space vector of the user's gaze on the basis of a predetermined vehicle coordinate system, and determines one electronic device from among the plurality of electronic devices to be the gesture recognition object on the basis of the coordinates and the space vector of the user's gaze.

22. The vehicle according to claim 13, further comprising:
an alarm unit to indicate activation of the gesture recognition object.

23. A method for controlling a vehicle comprising:
collecting information regarding a user gesture by a collection unit;
detecting coordinates and a space vector of the user gesture on the basis of a predetermined vehicle coordinate system; and
determining an electronic device from among a plurality of electronic devices to be a gesture recognition object on the basis of the gesture coordinates and the space vector.

24. The method according to claim 23, wherein the detection of the coordinates and the space vector of the user gesture on the basis of the predetermined vehicle coordinates includes:
detecting the coordinates and the space vector of the user gesture with respect to the vehicle coordinate system on the basis of a position of the collection unit with respect to the vehicle coordinate system.

25. The method according to claim 23, wherein the determination of the electronic device from among the plurality of electronic devices on the basis of the gesture coordinates and the space vector of the user gesture includes:
determining the electronic device from among the plurality of electronic devices to be the gesture recognition object, wherein the electronic device is located at an extension line of the space vector.

26. The method according to claim 23, further comprising:
outputting an operation command based on the collected gesture information to the electronic device determined to be the gesture recognition object.

27. The method according to claim 23, further comprising:
informing the user of activation of the gesture recognition object.

28. The method according to claim 23, wherein the determination of the gesture recognition object includes:
determining the gesture recognition object on the basis of information regarding the user's face,
wherein the determination of the gesture recognition object on the basis of the user face information includes:
collecting the user face information by a collection unit;
detecting coordinates and a space vector of the user face on the basis of a predetermined vehicle coordinate system; and
determining the electronic device from among the plurality of electronic devices to be the gesture recognition object on the basis of the coordinates and the space vector of the user face.

29. The method according to claim 23, wherein the determination of the gesture recognition object includes:
determining the gesture recognition object on the basis of information regarding a user's gaze of the user,
wherein the determination of the gesture recognition object on the basis of the user's gaze information includes:
collecting the user's gaze information by a collection unit;
detecting coordinates and a space vector of the user's gaze on the basis of a predetermined vehicle coordinate system; and
determining the electronic device from among the plurality of electronic devices to be the gesture recognition object on the basis of the coordinates and the space vector of the user's gaze.
